(19) United States
(12) Patent Application Publication
(10) Pub. No.: US 2010/0118848 A1
(43) Pub. Date: May 13, 2010

(54) COMMUNICATION TERMINAL AND IMAGE DATA TRANSFER METHOD

(75) Inventor: Mitsuru Satou, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/528,033

(22) PCT Filed: Feb. 20, 2007
(86) PCT No.: PCT/JP2007/053095

§ 371 Date: Aug. 20, 2009

(51) Int. Cl. H04W 40/00

(52) U.S. Cl. 370/338

(57) ABSTRACT

A communication terminal capable of easily transferring image data of a taken image and rapidly transferring the image data by using wireless LAN ad-hoc mode communication. In the terminal, a transmission section (109) transmits a beacon signal through a switching section (108) and an antenna (107) to search a terminal of the communication party. A WLAN wireless control unit (112) outputs the beacon signal, an ATIM signal, and the image data to the transmission section (109) and also outputs image data inputted from a reception section (110) to a WLAN interface (114) after the activation. When detecting the activation of a camera module (119), an application control block (116) requests to activate the wireless LAN ad-hoc mode communication. The camera module (119) takes an image by the key depression of an operation section (120) after the activation.

### TECHNICAL FIELD

The present invention relates to a communication terminal apparatus and image data transferring method. More particularly, the present invention relates to a communication terminal apparatus and image data transferring method for transferring image data using ad hoc mode communication of a wireless LAN.

### BACKGROUND ART

Heretofore, to transfer an image taken by a camera such as a mobile telephone and digital camera to another device, it is known to store image data of the taken image once in a storage medium and then transfer the image data after connecting the storage medium having stored the image data to a device of transfer destination.

Further, heretofore, it is known to transfer image data of an image taken by a camera to a mobile telephone (e.g. see Patent Document 1). The camera system of Patent Document 1 registers the telephone numbers of mobile telephone apparatuses in a camera having a communication function. If a mobile telephone apparatus makes a call to the camera, the camera authenticates the access party with the registered telephone numbers, and allows only the mobile telephone apparatuses of the registered telephone numbers to transmit/receive data such as images and control signals to/from the camera.

Up till now, ad hoc mode communication of a wireless LAN is actively studied as on-demand type communication.

Ad hoc mode communication of a wireless LAN is communication of an autonomous-distributed network formed with radio terminals that can perform wireless connection (such as personal computers, PDAs and mobile telephones) without base stations and access points. Therefore, ad hoc mode communication of a wireless LAN can construct a network and communicate easily even in places without infrastructures such as access points

With this ad hoc mode communication of a wireless LAN, communication is performed between terminals using techniques such as the techniques of IEEE (Institute of Electrical and Electronics Engineers) 802.1 and Bluetooth (trademark).

### Patent Document 1: Japanese Patent Application Laid-Open No. 2004-361464

### DISCLOSURE OF INVENTION

### Problems to be Solved by the Invention

However, a conventional apparatus has a problem that transferring image data is complicated when the image data is transferred via a storage medium. An example of this problem is that, when a group photograph is taken by a mobile telephone with camera or a digital camera, giving the photograph to all people in the photograph via a storage medium is laborious and complicated.

Further, the camera system of Patent Document 1 has a problem of requiring telephone number registration processing to register telephone numbers in the camera and requiring complicated processing to transfer image data from the camera to mobile telephones. There is another problem of requiring time to transfer image data because a communication scheme to transfer image data from a camera to mobile telephones employs FDMA, TDMA, CDMA and W-CDMA, whereby image data is transferred from the camera to the mobile telephones via a base station.

It is therefore an object of the present invention to provide a communication terminal apparatus and image data transferring method that can transfer image data of a taken image easily and transfer image data quickly using ad hoc mode communication of a wireless LAN.

### Means for Solving the Problem

The communication terminal apparatus of the present invention employs a configuration having: an imaging section that takes an image; an activation detecting section that detects an activation of the imaging section; a searching section that searches for a communicating party terminal in a predetermined cycle that can communicate in ad hoc mode communication of a wireless local area network, the ad hoc mode communication of the wireless local area network directly communicating with the communicating party terminal using, as a start, a sign signal transmitted or received when the activation is detected in the activation detecting section; and a transferring section that, when the communicating party terminal is found by a search in the searching section, transfers image data of the image taken by the imaging section to the communicating party terminal in the ad hoc mode communication of the wireless local area network.

The image data transferring method of the present invention includes: in an imaging section that is provided in a communication terminal apparatus, taking an image; detecting an activation of the imaging section; in the communication terminal apparatus, searching for a communicating party terminal in a predetermined cycle that can communicate in ad hoc mode communication of a wireless local area network, the ad hoc mode communication of the wireless local area network directly communicating with the communicating party terminal using, as a start, a sign signal transmitted or received when the activation is detected in the activation detecting section; and, when the communicating party terminal is found by the search, transferring image data of the image taken by the imaging section to the communicating party terminal in the ad hoc mode communication of the wireless local area network.

### ADVANTAGEOUS EFFECTS OF INVENTION

According to the present invention, it is possible to transfer image data of a taken image easily and transfer image data quickly using ad hoc mode communication of a wireless LAN.

### BRIEF DESCRIPTION OF DRAWINGS

FIG. 1 is a block diagram showing the configuration of a communication terminal apparatus according to an embodiment of the present invention;

FIG. 2 is a flowchart showing the operations of a communication terminal apparatus according to an embodiment of the present invention;

FIG. 3 is a diagram illustrating a condition of ad hoc mode communication according to an embodiment of the present invention;

FIG. 4 illustrates a timing chart diagram when ad hoc mode communication is performed according to an embodiment of the present invention;

FIG. 5 is a flowchart showing the operations of a communication terminal apparatus according to an embodiment of the present invention; and

FIG. 6 illustrates a timing chart diagram when ad hoc mode communication is performed according to an embodiment of the present invention.

### BEST MODE FOR CARRYING OUT THE INVENTION

An embodiment of the present invention will be explained below in detail with reference to the accompanying drawings.

### Embodiment

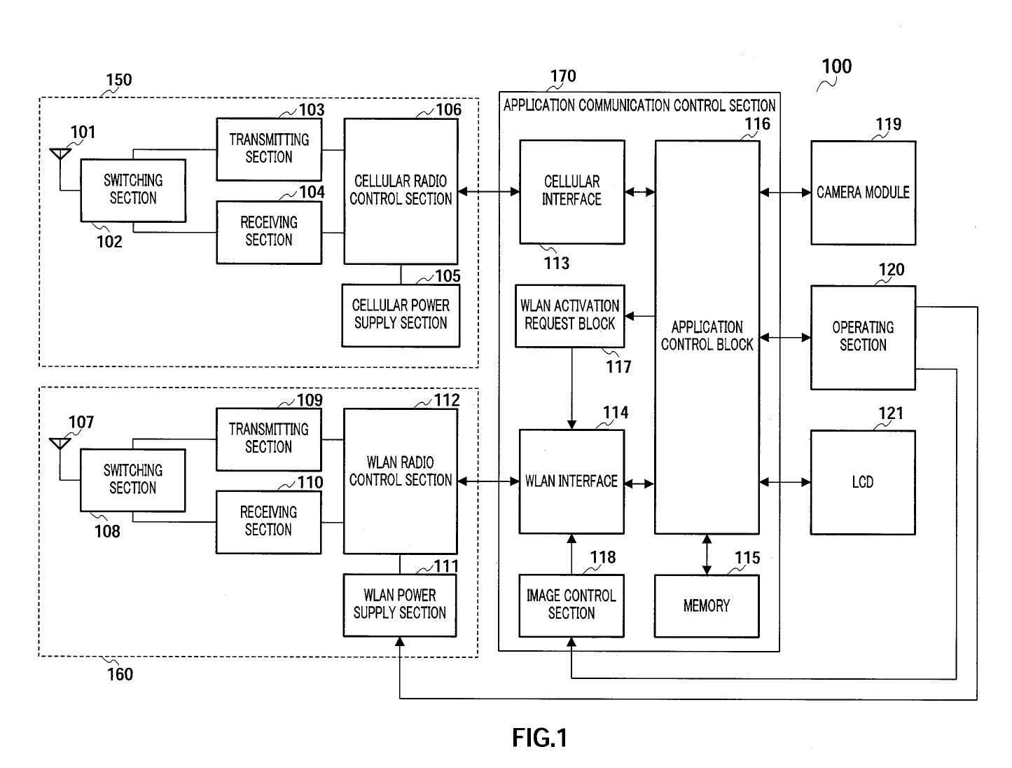

FIG. 1 is a block diagram showing the configuration of communication terminal apparatus 100 according to an embodiment of the present invention.

Antenna 101, switching section 102, transmitting section 103, receiving section 104, cellular power supply section 105 and cellular radio control section 106 form cellular communication section 150.

Antenna 107, switching section 108, transmitting section 109, receiving section 110, WLAN power supply section 111 and WLAN radio control section 112 form WLAN communication section 160. Cellular interface 113, WLAN interface 114, memory 115, application control block 116, WLAN activation request block 117 and imaging control section 118 form application communication control section 170.

Antenna 101 receives and outputs a signal of a cellular communication scheme to switching section 102, and transmits a transmission signal of the cellular communication scheme received as input from switching section 102.

Switching section 102 switches between outputting a received signal received as input from antenna 101 to receiving section 104 and outputting a transmission signal received as input from transmitting section 103 to antenna 101.

Transmitting section 103 performs up-conversion of a transmission signal received as input from cellular radio control section 106, from a baseband frequency to a radio frequency, and outputs the result to switching section 102.

Receiving section 104 performs down-conversion of the received signal received as input from switching section 102, from a radio frequency to a baseband frequency, and outputs the result to cellular radio control section 106.

Cellular power supply section 105 supplies power to cellular radio control section 106.

Cellular radio control section 106 receives a supply of power from cellular power supply section 105, and then modulates a transmission signal received as input from cellular interface 113 and outputs the result to transmitting section 103. Cellular radio control section 106 also demodulates the received signal received as input from receiving section 104 and outputs the result to cellular interface 113.

Antenna 107 receives a signal of ad hoc mode communication of a wireless LAN via a wireless ad hoc network and outputs it to switching section 108, and transmits a transmission signal of ad hoc mode communication of the wireless LAN, received as input from switching section 108, via the wireless ad hoc network.

Switching section 108 switches between outputting the received signal received as input from antenna 107 to receiving section 110 and outputting a transmission signal received as input from transmitting section 109 to antenna 107.

Transmitting section 109, which is a transfer means, performs up-conversion of a transmission signal received as input from WLAN radio control section 112, from a baseband frequency to a radio frequency, and outputs the result to switching section 108.

Receiving section 110 performs down-conversion of the received signal received as input from switching section 108, from a radio frequency to a baseband frequency, and outputs the result to WLAN radio control section 112.

WLAN power supply section 111 supplies power to WLAN radio control section 112 when receiving as input a search start signal from operation section 120.

WLAN radio control section 112, which is a searching means, is activated by receiving a supply of power from WLAN power supply section 111. If activated WLAN radio control section 112 does not receive as input from receiving section 110 a beacon signal transmitted by the communicating party terminal, WLAN radio control section 112 generates a beacon signal and outputs it to transmitting section 109. Here, when receiving as input a beacon cycle control signal to shorten the cycle of beacon transmission, from WLAN interface 114, WLAN radio control section 112 outputs the generated beacon to transmitting section 109 at the time a beacon is transmitted in the cycle in accordance with the beacon cycle control signal. By contrast, if activated WLAN radio control section 112 receives as input a beacon signal transmitted from the communicating party terminal, from receiving section 110, WLAN radio control section 112 generates an announcement traffic indication message (“ATIM”) signal and outputs the generated ATIM signal to transmitting section 109.

When receiving as input an ACK for the ATIM signal from receiving section 110, WLAN radio control section 112 modulates image data received as input from WLAN interface 114, and outputs the result to transmitting section 109. Further, with reference to the BSSID included in each frame of a received signal received as input from receiving section 110, WLAN radio control section 112 processes only image data of a frame including the same BSSID as the BSSID currently assigned to WLAN radio control section 112. WLAN radio control section 112 then outputs the processed image data to WLAN interface 114. Here, a BSSID (Basic Service Set ID) is an identifier to identify an access point or base station, but the BSSID of the present embodiment has a role of identification information to identify groups of communication terminal apparatuses when the communication terminal apparatuses are grouped. In this case, the image data outputted from WLAN radio control section 112 to transmitting section 109 is image data of the image that is taken by camera module 119 and transferred to the communicating party, and the image data received as input in WLAN radio control section 112 from receiving section 110 is the image data to display image data of the image being taken by the communicating party terminal on LCD 121 as a monitor image. Further, WLAN radio control section 112 modulates a control signal, which is received as input from WLAN interface 114 and which is used to remote-operate imaging processing when the communicating party terminal takes an image, and outputs the result to transmitting section 109.

Cellular interface 113 outputs a received signal received as input from cellular radio control section 106, to application control block 116. Further, cellular interface 113 outputs a transmission signal received as input from application control block 116, to cellular radio control section 106.

WLAN interface 114 requests an activation of WLAN radio control section 112 when receiving an activation request from WLAN activation request block 117. After having requested the activation, WLAN interface 114 outputs image data received as input from application control block 116 to WLAN radio control section 112 and outputs a control signal received as input from imaging control section 118 to WLAN radio control section 112, and outputs image data received as input from WLAN radio control section 112 to application control block 116. Further, when receiving as input, from application control block 116, a beacon cycle control signal to shorten the cycle of beacon transmission, WLAN interface 114 outputs the received beacon cycle control signal to WLAN radio control section 112.

Memory 115, which is a storage means, can store phonebook information (identification information), which is information about the destination address of a specific communicating party terminal. To be more specific, memory 115 stores the BSSID of IBSS (Independent Basic Service Set) as phonebook information. Further, memory 115 stores image data of an image, which is received as input from application control block 116 and taken by camera module 119. Here, IBSS represents a wireless LAN network which does not use access points and in which a transmitter is a transmission source and a receiver is a communicating party.

When receiving as input a camera activation signal from operating section 120, application control block 116, which is an activation detecting means, detects the activation of camera module 119 and commands WLAN activation request block 117 to activate ad hoc mode communication of the wireless LAN in a predetermined cycle. In this case, with reference to memory 115, if phonebook information is stored in memory 115, application control block 116 outputs to WLAN interface 114 a beacon cycle control signal to shorten the cycle of beacon transmission, compared to a case where phonebook information is not stored in memory 115. After having requested the activation, application control block 116 also outputs image data received as input from camera module 119, to WLAN interface 114. Further, application control block 116 outputs the image data received as input from WLAN interface 114, to LCD 121. Further, when receiving as input a signal in accordance with a key operation in operating section 120 from operating section 120, application control block 116 performs predetermined application processing in accordance with the key operation. Further, application control block 116 inputs and outputs a cellular communication scheme signal with cellular interface 113 by performing predetermined application processing. Further, application control block 116 stores image data received as input from camera module 119 in memory 115 according to a command signal received as input from operating section 120, which will be described later.

WLAN activation request block 117 requests an activation to WLAN interface 114 according to the command from application control block 116.

Based on a signal received as input from operating section 120, imaging control section 118 generates a control signal to control imaging processing by remote operations when the communicating party takes an image, and outputs the generated control signal to WLAN interface 114. For example, imaging control section 118 generates a control signal for adjusting focus, or generates a control signal for adjusting the view angle of the camera. Further, when receiving as input a selection signal from operating section 120, imaging control section 118 generates a control signal for requesting transmission of image data of the image, which is currently taken by the communicating party terminal, as a monitor image.

Camera module 119, which is an imaging means, has an activation switch and is activated by a press of the activation switch. Further, after activation, camera module 119 takes an image of the object and outputs image data of the taken image of the object to application control block 116.

Operating section 120, which is a selecting means, has operation keys, and, when the operation keys are operated externally, outputs the signal in accordance with the key operation, to application control block 116. Further, if the key operation controls imaging processing by remote operations in the case of imaging in the communicating party terminal, operating section 120 outputs a signal for remote operation associated with the key operation, to imaging control section 118. Further, if the key operation commands displaying as a monitor image the image being taken by the communicating party terminal, operating section 120 outputs a selection signal for selecting displaying the monitor image, to imaging control section 118. Further, if the key operation commands storing image data of the image taken by camera module 119, operating section 120 outputs a command signal for commanding storing the image data, to application control block 116. Further, operating section 120 has a camera activation switch and a search start switch of the WLAN communicating party terminal. When the camera activation switch is pressed, operating section 120 outputs a camera activation signal to application control block 116. Further, when the search start switch of the WLAN communicating party terminal is pressed, operating section 120 outputs a search start signal to WLAN power supply section 111.

LCD 121, which is a display means, displays an image of image data received as input from application control block 116. In this case, if the image data received as input from application control block 116 is image data of the image being taken by the communicating party terminal, LCD 121 displays, as a monitor image, the image being taken by the communicating party terminal.

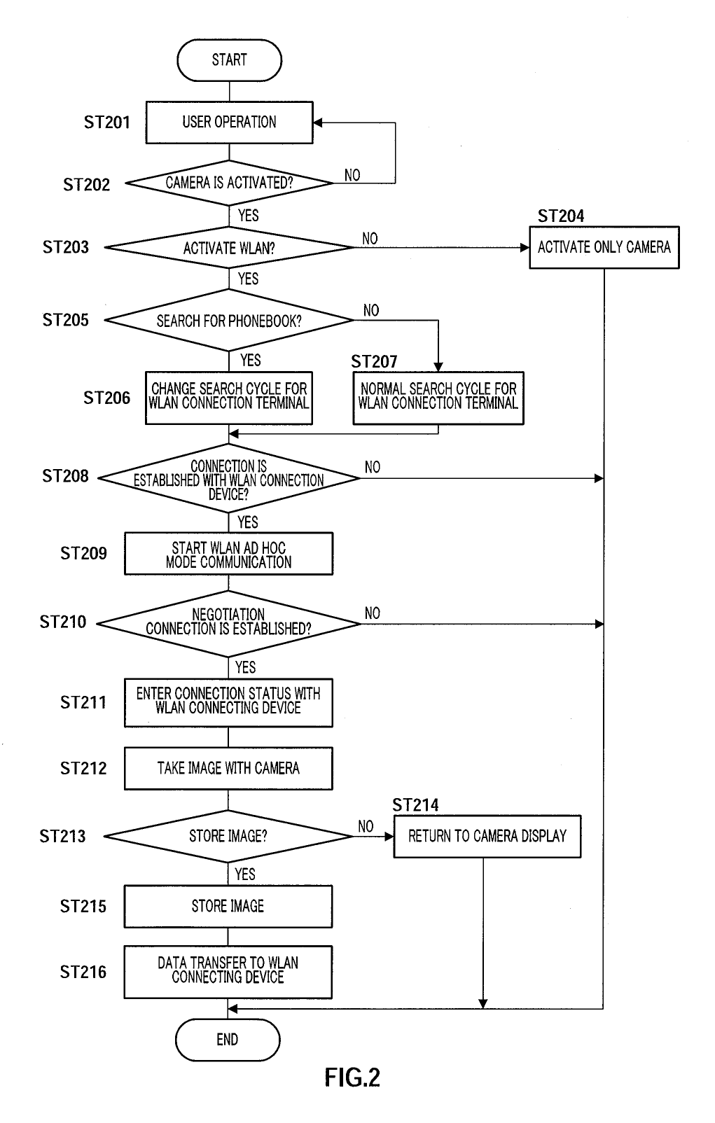

Next, the operations of communicating terminal apparatus 100 in the case of transferring image data of a taken image to the communicating party terminal, will be explained using FIG. 2. FIG. 2 is a flowchart showing the operations of communication terminal apparatus 100.

First, communication terminal apparatus 100 accepts user operations (step ST201).

Next, application control block 116 of communication terminal apparatus 100 decides whether or not the camera of camera module 119 is activated (step ST202).

If the camera is not activated, communication terminal apparatus 100 accepts user operations again (step ST201).

By contrast, if the camera is activated, application control block 116 of communication terminal apparatus 100 decides whether or not to activate a wireless LAN (“WLAN”) (step ST203).

If the wireless LAN is not activated, communication terminal apparatus 100 keeps the activation of only camera module 119 (step ST204).

By contrast, if the wireless LAN is activated in step ST203, application control block 116 decides whether phonebook information is stored in memory 115 and whether or not it is necessary to search for the phonebook information (step ST205).

If it is necessary to search for the phonebook information, application control block 116 determines to change the beacon transmission cycle to be shorter (step ST206).

By contrast, if it is not necessary to search for the phonebook information, application control block 116 sets the beacon transmission cycle to a normal cycle, that is, to a longer beacon cycle than the beacon cycle set in step ST206 (step ST207).

Next, WLAN radio control section 112 of communication terminal apparatus 100 decides whether or not connection is established with a wireless LAN connecting device (step ST208). To be more specific, WLAN radio control section 112 transmits a beacon in the set beacon cycle and then transmits an ATIM signal. When receiving an ACK for the ATIM signal from the communicating party terminal, WLAN radio control section 112 decides that connection is established with the wireless LAN connecting device. Also, when receiving a beacon and ATIM signal transmitted from the communicating party terminal, WLAN radio control section 112 decides that connection is established with the wireless LAN connecting device.

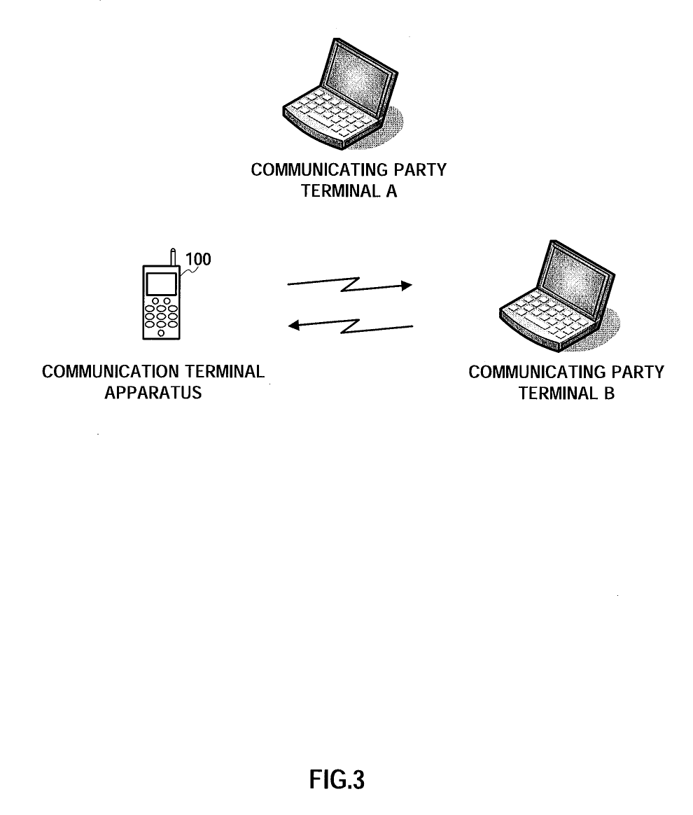

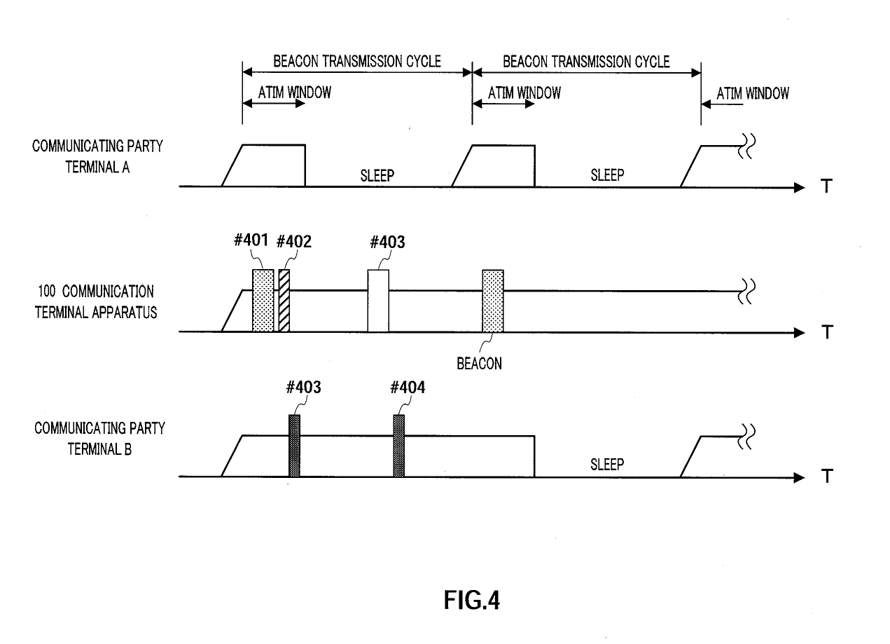

FIG. 3 is a diagram illustrating a state of performing ad hoc mode communication, and FIG. 4 is a timing chart diagram when ad hoc mode communication is performed. In FIG. 3 and FIG. 4, communication terminal apparatus 100 has the same configuration as in FIG. 1.

Referring to FIG. 3, communication terminal apparatus 100 performs ad hoc mode communication with communicating party terminal B and does not perform ad hoc mode communication with communicating party terminal A.

In this case, referring to FIG. 4, communication terminal apparatus 100 transmits beacon #401. Further, with this transmission of beacon #401 as a start, communication terminal apparatus 100 then transmits ATIM signal #402 to communicating party terminal B by unicast. Communicating party terminal A having received ATIM signal #402 does not participate in ad hoc mode communication with communication terminal apparatus 100, and therefore does not transmit a response signal. On the other hand, communicating party terminal B having received ATIM signal #402 that is directed to communicating party terminal B, participates in ad hoc mode communication with communication terminal apparatus 100, and therefore transmits ACK #403 in response to ATIM signal #402. When receiving ACK #403, communication terminal apparatus 100 can decide that communication terminal apparatus 100 is connected with the wireless LAN connecting device. Also, when communication terminal apparatus 100 cannot receive ACK #403 or communicating party terminal B does not transmit ACK #403, communication terminal apparatus 100 can decide that communication terminal apparatus 100 is not connected with the wireless LAN connecting device.

In FIG. 4, communication terminal apparatus 100 and communicating party terminals A and B hold them for a random waiting time called “back-off” from the target beacon transmission time “TBTT,” which corresponds to the end time of the previous beacon period, and try to transmit a beacon signal. If communication terminal apparatus 100 and communicating party terminals A and B receive a beacon signal before their transmission time, they cancel transmission of pending beacon signals. By this means, in ad hoc mode communication, only one of communication terminal apparatus 100 and communicating party terminals A and B transmits a beacon signal.

A beacon frame needs to be processed by communication terminal apparatus 100 and communicating party terminals A and B, and, consequently, communication terminal apparatus 100 and communicating party terminals A and B each start and enter an activation state before the TBTT. Here, a beacon frame contains essential fields including the time stamp, beacon period, capability information, service set ID and support rate, and option fields including the FH parameter set, DS parameter set, CF parameter set, IBSS parameter set and TIM. Option information is present only when it needs to be used.

Returning to FIG. 2, if it is decided that connection is established with a wireless LAN connecting device in step ST208, communication terminal apparatus 100 starts ad hoc mode communication of the wireless LAN (step ST209).

Next, communication terminal apparatus 100 performs negotiation with the communicating party terminal with which communication terminal apparatus 100 starts ad hoc mode communication of the wireless LAN, and decides whether or not negotiation connection is established (step ST210).

If the negotiation connection can be established, communication terminal apparatus 100 and the communicating party terminal enter a connection state with a wireless LAN connecting device by ad hoc mode communication (step ST211).

Next, camera module 119 takes an image of an object (step ST212).

Next, application control block 116 of communication terminal apparatus 100 decides whether or not to store image data of the image taken by camera module 119 in memory 115 (step ST213).

If it is decided not to store the image data in memory 115, the process returns to camera display (step ST214).

By contrast, if it is decided to store the image data in memory 115 in step ST 213, application control block 116 stores the image data in memory 115 (step ST215).

Next, WLAN radio control section 112 of communication terminal apparatus 100 starts transferring the image data to the communication terminal party having entered the connection state in step ST211, using ad hoc mode communication of the wireless LAN (step ST216). To be more specific, as shown in FIG. 4, WLAN radio control section 112 transfers image data #403, and communicating party terminal B having received image data #403 transmits an ACK (not shown) in response to the received image data.

On the other hand, if only camera module 119 is activated in step ST204, if it is decided that connection is not established with the wireless LAN connecting device in step ST208, if negotiation connection cannot be established in step ST210, or if process returns to camera display in step ST214, communication terminal apparatus 100 does not transfer image data.

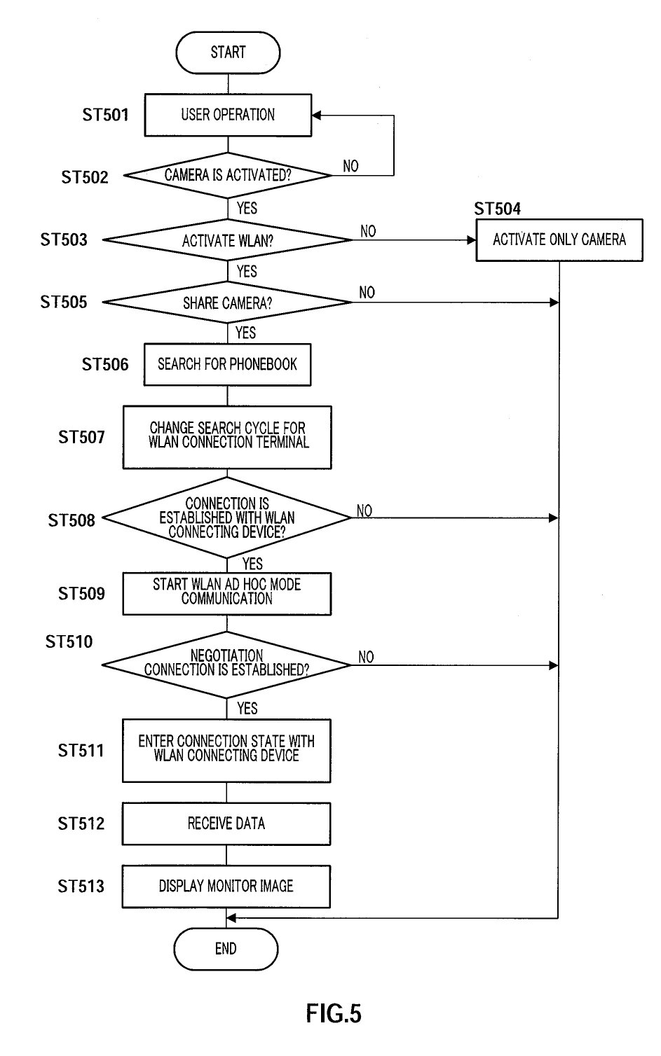

Next, the operations of communication terminal apparatus 100 in the case where an image taken by a communicating party terminal is displayed as a monitor image, will be explained using FIG. 5. FIG. 5 is a flowchart showing the operations of communication terminal apparatus 100.

First, communication terminal apparatus 100 accepts user operations (step ST501).

Next, camera module 119 of communication terminal apparatus 100 decides whether or not the camera is activated (step ST502).

If the camera is not activated, communication terminal apparatus 100 accepts user operations again (step ST501).

By contrast, if the camera is activated, application control block 116 of communication terminal apparatus 100 decides whether or not to activate a wireless LAN (“WLAN”) (step ST503).

If the wireless LAN is not activated, communication terminal apparatus 100 keeps the activation of only camera module 119 (step ST504).

By contrast, in step ST504, if the wireless LAN is activated, application control block 116 decides whether or not to receive as input, from operating section 120, a signal selecting displaying the image being taken by the communicating party terminal, that is, whether or not to share the camera (step ST505).

If the camera is shared, application control block 116 searches for phonebook information stored in memory 115 (step ST506).

Next, application control block 116 determines to change the beacon transmission cycle to be shorter (step ST507).

Next, WLAN radio control section 112 of communication terminal apparatus 100 decides whether or not connection is established with the wireless LAN connecting device (step ST508). To be more specific, WLAN radio control section 112 transmits a beacon in the set beacon cycle and then transmits an ATIM signal. When receiving ACK for the ATIM signal from the communicating party terminal, WLAN radio control section 112 decides that connection is established with a wireless LAN connecting device. Also, when receiving a beacon and ATIM signal transmitted from the communicating party terminal, WLAN radio control section 112 decides that connection is established with a wireless LAN connecting device. Here, the determination method is the same as in FIG. 3 and FIG. 4, and therefore detailed explanation will be omitted.

If it is decided that connection is established with a wireless LAN connecting device in step ST508, communication terminal apparatus 100 starts ad hoc mode communication of the wireless LAN (step ST509).

Next, communication terminal apparatus 100 performs negotiation with the communicating party terminal with which communication terminal apparatus starts ad hoc mode communication of the wireless LAN, and decides whether or not negotiation connection is established (step ST510).

If the negotiation connection is established, communication terminal apparatus 100 and the communicating party terminal enters a connection state with a wireless LAN connecting device by ad hoc mode communication (step ST511).

Next, imaging control section 118 of communication terminal apparatus 100 generates a control signal for requesting transfer of the image data being taken by the communicating party terminal. Communication terminal apparatus 100 then transmits a control signal for requesting transfer of the image data being taken by the communicating party terminal.

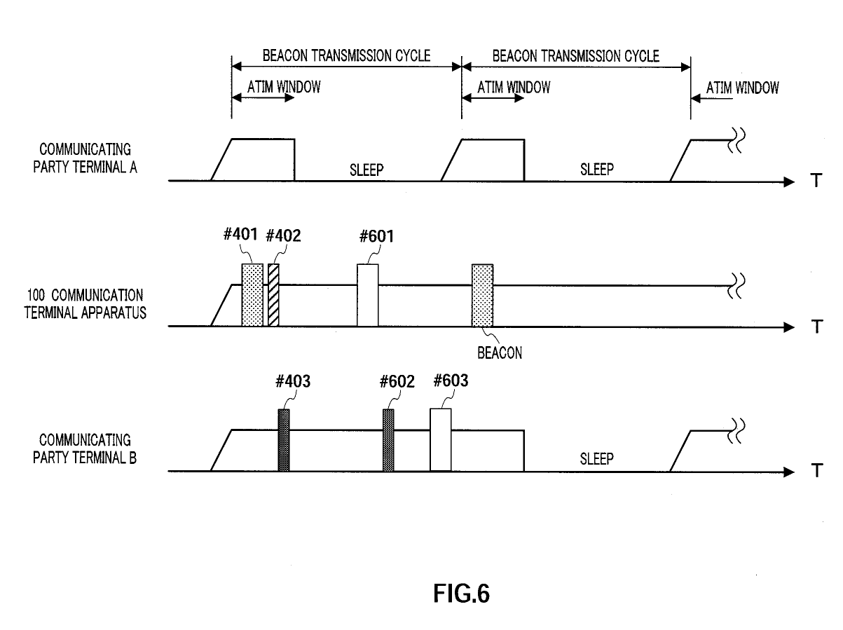

FIG. 6 is a timing chart diagram when ad hoc mode communication is performed. In FIG. 6, the same components as in FIG. 4 will be assigned the same reference numerals and their explanation will be omitted.

From FIG. 6, communication terminal apparatus 100 transmits control signal #601 for requesting transfer of the image data being taken by the communicating party terminal, and the communicating party terminal B having received control signal #601 transmits ACK #602 in response to reception of control signal #601.

Next, as shown in FIG. 6, communication terminal apparatus 100 receives image data #603 transmitted from the communicating party terminal (step ST512).

Next, LCD 121 of communication terminal apparatus 100 displays image data received in step ST512 as a monitor image (step ST513).

On the other hand, if only camera module 119 is activated in step ST504, if the camera is not shared in step ST505, if it is decided that connection is not established with the wireless LAN connecting device in step ST508, or if negotiation connection cannot be established in step ST510, communication terminal apparatus 100 does not transfer image data.

By the way, as shown in FIG. 4 and FIG. 6, a beacon signal represents a sign signal in ad hoc mode communication of the wireless LAN and is transmitted to all radio terminals. A beacon can be transmitted at predetermined intervals from any of communication terminal apparatus 100 and communicating party terminals A and B.

In response to this beacon, a time window called “ATIM window” starts in communication terminal apparatus 100 and communicating party terminals A and B. This ATIM window is a time nodes (here, communication terminal apparatus 100 and communication terminals A and B) must keep an active state.

In ad hoc mode communication, communication terminal apparatus 100 and communicating party terminals A and B transmit an ATIM signal during the ATIM window, whereby communicating party terminal A cannot turn the power supply “on” during the ATIM window, and the ATIM window ends a time determined upon establishing IBSS after the time the power is turned “on.”

Further, wireless terminal A has not transmitted or received an ATIM signal, and therefore can enter a sleep state (power saving mode) after the ATIM window ends. Further, radio terminal A is activated to transmit or receive a beacon signal in the beacon transmission cycle.

Also, if other communication terminal apparatuses than communicating party terminals A and B want to participate in a network that has already been structured, communication terminal apparatus 100 that transmits beacons does not enter a sleep state until the next beacon transmission, so as to give a chance to participate in the network to other communication terminal apparatuses that want to participate in the network.

By the way, communication terminal apparatus 100 and communicating party terminal B transmit and receive an ATIM signal during the ATIM window and therefore cannot enter a sleep state.

Also, communication terminal apparatus 100 having transmitted a beacon accepts a new entry of external radio terminals for ad hoc mode communication, and therefore cannot enter a sleep state.

In the ATIM window upon transmitting the next beacon, communication terminal apparatus 100 and communicating party terminals A and B do not transmit and receive an ATIM signal, and therefore communicating party terminals A and B, excluding communication terminal apparatus 100 having transmitted a beacon, enter a sleep state after the ATIM window ends.

The BSSID is stored in all frames such that communication terminal apparatuses and other devices can check data subjected to broadcasting or multicasting. By this means, only the communication terminal apparatuses and other devices that belong to the same BSSID can receive data subjected to broadcasting or multicasting. Further, three address fields are used in IBSS. The address of the receiver is stored in the first address field, and, in the case of IBSS, this address is the same as the address of the communicating party. The address of the transmission source is stored in the second address field. The BSSID is stored in the third address field. Further, the IBSS has only one parameter and ATIM windows. This field is only used in beacon frames in the IBSS.

Thus, according to the present embodiment, by transferring image data using ad hoc mode communication of a wireless LAN, it is possible to transfer image data of a taken image easily and transfer image data quickly. Further, upon distributing a group photograph or the like, the present embodiment can realize this easily. Further, the present embodiment can remote-operate a communicating party terminal while looking at a monitor display, so that it is possible to eliminate the process of repeating taking an image. Further, the present embodiment shortens the beacon cycle if phonebook information is stored, thereby enabling image data to be transferred quickly to a target party.

### INDUSTRIAL APPLICABILITY

The communication terminal apparatus and image data transferring method according to the present invention are useful especially for transferring image data using ad hoc mode communication of a wireless LAN.

1. A communication terminal apparatus comprising:
an imaging section that takes an image;
an activation detecting section that detects an activation of the imaging section;
a searching section that searches for a communicating party terminal in a predetermined cycle that can communicate in ad hoc mode communication of a wireless local area network, the ad hoc mode communication of the wireless local area network directly communicating with the communicating party terminal using, as a start, a sign signal transmitted or received when the activation is detected in the activation detecting section; and
a transferring section that, when the communicating party terminal is found by a search in the searching section, transfers image data of the image taken by the imaging section to the communicating party terminal in the ad hoc mode communication of the wireless local area network.

2. The communication terminal apparatus according to claim 1, further comprising a storing section that stores identification information for identifying the communicating party terminal,
wherein, when the storing section stores the identification information, the searching section shortens the cycle compared to when the storing section does not store the identification information.

3. The communication terminal apparatus according to claim 1, wherein:
the imaging section is activated when a camera activation button is pressed; and
the activation detecting section detects the activation when the camera activation button is pressed.

4. The communication terminal apparatus according to claim 1, wherein the transferring section transfers the image data to the communicating party terminal when the storing section stores the image data.

5. The communication terminal apparatus according to claim 1, wherein the searching section stops the search when the communicating party terminal cannot be found within a predetermined time.

6. The communication terminal apparatus according to claim 1, further comprising:
a receiving section that receives image data of an image being taken by the communicating party terminal in the ad hoc mode communication of the wireless local area network, when the communicating party terminal is found by the search in the searching section; and
a displaying section that displays the received image data as a monitor image.

7. The communication terminal apparatus according to claim 6, further comprising:
an imaging control section that generates a control signal for controlling imaging processing of the image being taken in the communicating party terminal that transmits the image data; and
a transmitting section that transmits the control signal generated in the imaging control section to the communicating party terminal in the ad hoc mode communication of the wireless local area network.

8. The communication terminal apparatus according to claim 6, further comprising:
a selecting section that selects whether to display the monitor image,
wherein the receiving section receives the image data when displaying the monitor image is selected in the selecting section.

9. An image data transferring method comprising the steps of:
in an imaging section that is provided in a communication terminal apparatus, taking an image;
detecting an activation of the imaging section;
in the communication terminal apparatus, searching for a communicating party terminal in a predetermined cycle that can communicate in ad hoc mode communication of a wireless local area network, the ad hoc mode communication of the wireless local area network directly communicating with the communicating party terminal using, as a start, a sign signal transmitted or received when the activation is detected in the activation detecting section; and
when the communicating party terminal is found by the search, transferring image data of the image taken by the imaging section to the communicating party terminal in the ad hoc mode communication of the wireless local area network.

10. The image data transferring method according to claim 9, further comprising a step of, in the communication terminal apparatus, receiving as a monitor image the image data of an image being taken by the communicating party terminal in the ad hoc mode communication of the wireless local area network, when the communicating party terminal is found.
